(19) United States
(12) Patent Application Publication
(10) Pub. No.: US 2010/0211304 A1
(43) Pub. Date: Aug. 19, 2010

(54) Personalized User Routing and Recommendations

(76) Inventors: Timothy H. Hwang, Philadelphia, PA (US); Edward A. Ehrlacher, Philadelphia, PA (US); Charles A. Eldering, Furlong, PA (US)

Correspondence Address: Carlineo, Spicer & Kee, LLC, 2003 S. Easton Road, Suite 208, Doylestown, PA, 18901, US

(21) Appl. No.: 12/388,979

(22) Filed: Feb. 19, 2009

(51) Int. Cl. G01C 21/36

(52) U.S. Cl. 701/200

(57) ABSTRACT

Methods and systems of personalizing navigation for a user on a computer system are generally disclosed. Example methods and systems can be arranged for evaluating user observation data received from a navigation device remote from the computer system over a network includes receiving, at the computer system, the user observation data and a route request associated with the user. A user identity associated with the route request can be determined based at least in part on the received user observation data. One or more preferences can be evaluated to select a specific preference associated with the user identity. A route can be compiled, on a processing module, based at least in part on the specific preference. The compiled route can be provided over the network to the navigation device.

### BACKGROUND

This disclosure generally relates to networked navigation systems, and more specifically to providing personalized routes.

Global Positioning System (GPS) navigation devices containing built in routing modules and map data are capable of providing routes based upon the start point and end destination of a driver. Such devices may be portable or built in to the vehicle and may be purchased as an after-market option or as a built in feature of the vehicle. Widely available GPS devices offer features such as Bluetooth connectivity and traffic updates. These devices operate independent of the identity of the driver of the vehicle, providing the same route and travel information regardless of who is operating the vehicle.

### BRIEF DESCRIPTION OF THE DRAWINGS

The following detailed description will be better understood when read in conjunction with the appended claims, taken in conjunction with the accompanying drawings, in which there is shown one or more of the multiple embodiments of the present disclosure. It should be understood, however, that the various embodiments of the present disclosure are not limited to the precise arrangements and instrumentalities shown in the drawings.

In the Drawings:

FIG. 1 is a system diagram illustrating a personalized navigation service;

FIG. 2 is a block diagram illustrating user equipment according to the personalized navigation service of FIG. 1;

FIG. 3 is a sequence diagram illustrating the process for providing a personalized route to a user for the personalized navigation service of FIG. 1;

FIG. 4 is a sequence diagram illustrating the process for assigning users to user groups for the personalized navigation service of FIG. 1;

FIG. 5 is a use case diagram associated with determining a personalized route according to the personalized navigation service of FIG. 1;

FIG. 6 is a block diagram illustrating a computer system through which the embodiments of the present disclosure may be implemented;

FIG. 7 is a block diagram illustrating a navigation server according to the personalized navigation service of FIG. 1; and

FIG. 8 is a class diagram for determining a personalized route according to the personalized navigation service of FIG. 1, all arranged in accordance with the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

Unified Modeling Language (“UML”) can be used to model and/or describe methods and systems and provide the basis for better understanding their functionality and internal operation as well as describing interfaces with external components, systems and people using standardized notation. When used herein, UML diagrams including, but not limited to, use case diagrams, class diagrams and activity diagrams, are meant to serve as an aid in describing the embodiments of the present disclosure, but do not constrain implementation thereof to any particular hardware or software embodiments.

This disclosure is drawn, inter alia, to methods, apparatus, computer programs and systems related to travel route selection technology, and, more particularly, to the personalized generation of routes for users with networked navigation and positioning devices. A route refers to one or more courses, roads, road segments or combinations thereof that link a start location and a destination location. Given a user seeking a route to a destination, the multiple embodiments described herein present a route optimized to the driving style of the user. The system may also present point of interest (POI) information that may be of interest to the user. The optimized routes and POI information may be generated by identifying a user group to which the requesting user belongs.

For clarity, some embodiments of the subject matter disclosed herein are described with respect to an automobile and a wireless system. However, in light of the present disclosure those skilled in the art will recognize that the suggested travel routing techniques described herein may be used with any mode of travel and any communication system generally known in the art, including air travel, fixed and mobile computing devices such as a PDA or personal computer, and wireless communication devices and channels such as cellular telephone networks, WiFi and WiMax networks, wired telephone networks, and cable networks.

Briefly stated, the multiple embodiments of the present disclosure include methods of personalizing navigation for a user on a computer system by evaluating user observation data received from a navigation device remote from the computer system over a network. Some described methods include receiving, at the computer system, the user observation data and a route request associated with the user. A user identity associated with the route request can be determined based at least in part on the received user observation data. One or more preferences can be evaluated to select a preference associated with the user identity. A route can be compiled, on a processing module, based at least in part on the preference. The compiled route can be provided over the network to the navigation device.

The present disclosure includes an example navigation server that may include a receiving module configured to receive observation data and route request messages from a navigation device. A user identification module can be configured to determine a user identity associated with the route request messages based at least in part on the received observation data. A preference selection module can be configured to identify a preference associated with the determined user identity. A route creation module can be configured to compile a route based at least in part on the identified preference and a transmission module can be configured to provide the compiled route to the navigation device.

The present disclosure also applies to articles of manufacture that personalize navigation for a user, where the article of manufacture can evaluate user observation data received from a remotely located navigation device. Some example articles of manufacture comprise a computer-readable medium for holding computer-executable instructions. The computer-executable instructions can be configured to allow receiving user observation data and a route request associated with the user. A user identity associated with the route request can be determined based at least in part on the received user observation data. One or more preferences can be evaluated to select a preference associated with the user identity. A route can be compiled based at least in part on the preference. The compiled route can be provided to the navigation device.

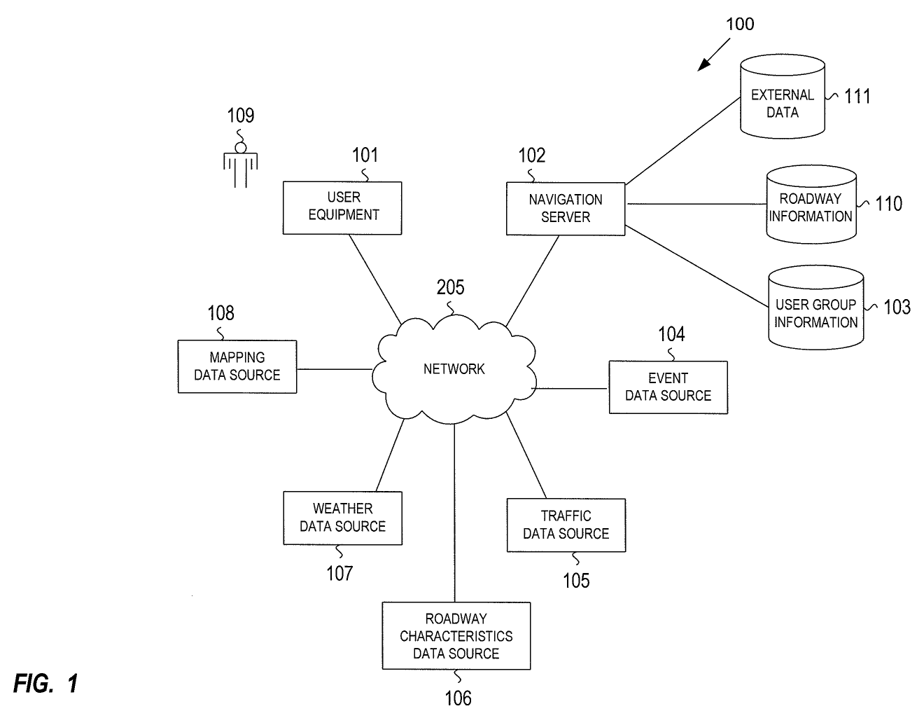

FIG. 1 is a system diagram illustrating a personalized navigation service 100 arranged in accordance with the present disclosure. The personalized navigation service 100 includes user equipment 101, a navigation server 102, and external data sources. The external data sources may include one or more of an event data source 104, a traffic data source 105, a roadway characteristics data source 106, a weather data source 107, and a geographic mapping data source 108. In addition, the navigation server 102 may be associated with one or more of a database of user group information 103, a database of roadway information 110 and a database of external data 111. The databases 103, 110, 111, and any other databases or storage systems or devices utilized by the personalized navigation service 100 may be maintained on optical, magnetic, tape or solid state storage generally known in the art or any combination thereof. By combining information from the external data sources (e.g., one or more of 104, 105, 106, 107, and 108) and the information from databases (e.g., one or more of 103, 110, and 111) the navigation server 102 provides an optimal route and POI information for a user. The personalized navigation service 100 may be maintained on a computer system comprising one or more computers.

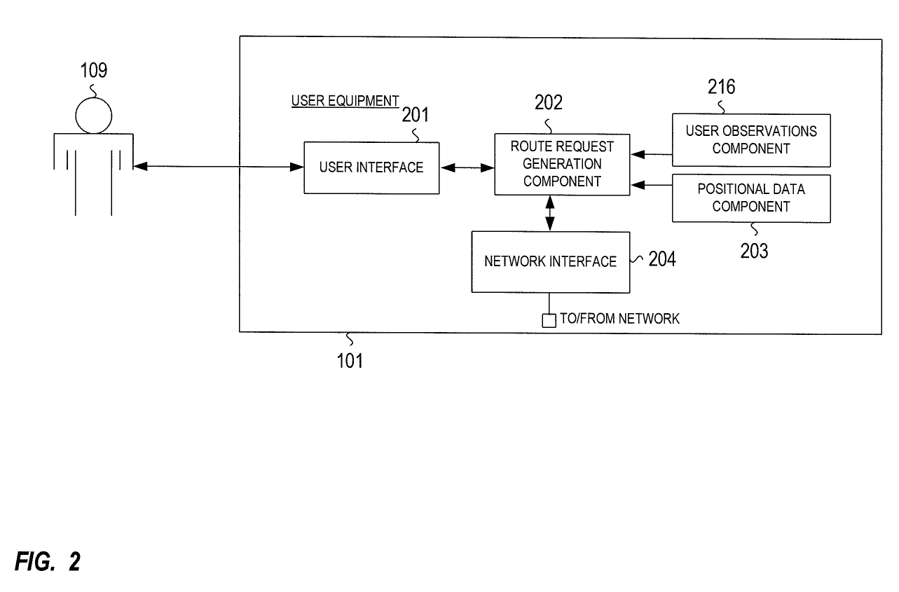

The user equipment (UE) 101 is generally a mobile or fixed communication device. Examples of UE 101 include, without limitation, Personal Digital Assistants (PDA), cell phones (including smart phones), personal computers, and in-vehicle navigation devices (both OEM and after-market). Such communication devices are generally known in the art, and a detailed discussion thereof is omitted here for convenience only and should not be considered limiting. A user 109, such as an operator, a pilot or a driver of a vehicle, interacts with the UE 101 via a user interface 201 (see FIG. 2) associated with the UE 101, in any manner generally understood in the art (e.g., GUI, keypad, touch-screen, etc.).

The UE 101 gathers real-time information about the user 109. This information may include, for example, the user's geographic location, direction, speed, and time such data was obtained. In some embodiments, the UE 101 also collects data which indicates user preferences based on user input or past travel habits. For example, the UE 101 may monitor and report searches for a particular POI. An example UE 101 that includes an internal position sensing device may automatically determine the start location based on the current position or location of the user. Such an example device may employ any position sensing technique generally known in the art, including, without limitation, Global Positioning System (GPS), cell triangulation, inertial sensing, or some combination thereof. In some examples, the user 109 may manually input a start location into the UE 101.

FIG. 2 is a block diagram illustrating user equipment according to the personalized navigation service of FIG. 1, arranged in accordance with the present disclosure. In some embodiments, a route request generation component 202 in the UE 101 generates route request messages that are sent to the navigation server 102 (not shown). A route request message may be generated by user input via interaction with the UE 101. The UE 101 may also automatically generate route request messages based on an event trigger (e.g., a user's deviation from an assigned route or detection of traffic volume above or below a threshold). A route request message includes information for the navigation server 102 to provide directions from the user's current location to a desired destination location. Examples of information incorporated in a route request message include, without limitation, observations of the user's driving habits (as discussed in greater detail below), a user identifier, a start location, a destination location, vehicle classification (e.g., number of axels, weight, etc.), and toll preferences.

In some embodiments the information included in the route request message is gathered from one or more components in the UE 101. For example, in FIG. 2, a positional data component 203 provides data that indicates the user's current location. The positional data component 203 may include, for example, a GPS receiver (not shown). A user observations component 216 may be employed to supply one or more user observations related to past, current, and future interactions between the user 109, a vehicle (not shown) and/or the user equipment 101. These observations may include one or more of a rate of acceleration, a rate of deceleration, an average speed, an average distance of travel, a time of travel, selected roadways, types of roads traveled, vehicle type, frequent destinations, stops along a route, and a use or a lack of use of turn signals. The observations may be augmented with additional information made available to the UE 101, such as cell phone call data, music selection and volume preferences, seat positions and climate control settings. The additional information may be observed by the UE 101 or provided by the vehicle to the UE 101 through a wired or wireless connection. The augmented observation data may also be transmitted to the navigation server 102 via network interface 204. Those skilled in the art will recognize various other observations that may be made by a navigation device (i.e., the user equipment 101) for use in formulating a route request message.

Observations obtained or recorded by the UE 101 may be stored in the user observations component 216 prior to being sent to the navigation server 102 via the network interface 204. A timestamp corresponding to each observation may be stored along with the observations. Observations about distinct trips may be separated based on the timestamps to create independent trip data.

Depending on privacy settings, the observation data stored in the user observations component 216 may be transmitted to the navigation server 102 periodically, at pre-defined times, or when a route request message is issued by the route request generation component 202. Though observations are not a required part of a route request message, if the navigation server 102 does not have any observation data for the UE 101, it may request that UE 101 provide observation data prior to calculating a route. When observations are transmitted along with a route request, the user observations component 216 determines which observations should be transmitted. These observations may then be transmitted in a request message along with any other information required for creating a personalized route. Alternatively, when privacy settings allow transmitting of observation updates without a route request, the user observations component 216 may issue update messages to be transmitted to the navigation server 102 with a UE identifier.

The observation data to be transmitted may include observations of the driver's interactions with the vehicle stored in user observations component 216 and their associated time stamps. Any additional information recorded by the navigation device may be transmitted along with collected driver observation data to the navigation server 102, though transmission of the additional information is not necessary for the operation of this embodiment and may depend on user's privacy settings. User privacy settings may be input by the user 109 through user interface 201 in UE 101. The observation data may be transmitted segmented into distinct trips or may be transmitted in bulk for analysis by the navigation server 102. The UE101 may optionally perform analysis on the observation data prior to such transmission. Optionally, the user may select how data should be provided to the navigation server 102. To transmit the data, network interface 204 communicates with navigation server 102 over the network 205.

The network 205 may be any network or system generally known in the art, including the Internet, an intranet, a local area network (LAN), a wide area network (WAN), a metropolitan area network (MAN), a direct connection or series of connections, a cable television infrastructure, a cellular telephone network or any other network, transmission channel or medium capable of facilitating communication between the devices, modules and other components of the personalized navigation service 100. The network may be wired, wireless or a combination thereof. Wired connections may be implemented using Ethernet, Universal Serial Bus (USB), RJ-11 or any other wired connection generally known in the art. Wireless connections may be implemented using wifi, wimax, bluetooth, infrared, cellular networks, satellite or any other wireless connection methodology generally known in the art. The network may be implemented in a client-server, token-ring, peer-to-peer manner or any other network topology known in the art. Additionally, several networks may work alone or in communication with each other to facilitate communication in the network 205. Various networking standards may be employed for allowing UE 101 to communicate with the network 205 (see FIG. 1), such as EDGE, 3G and/or 802.11.

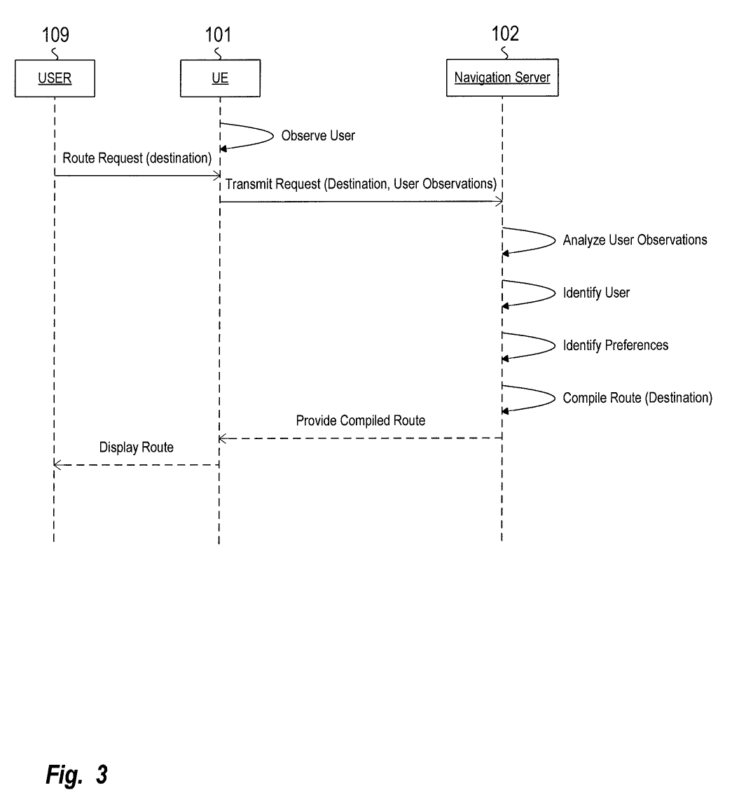

FIG. 3 is a sequence diagram illustrating the process for providing a personalized route to a user for the personalized navigation service of FIG. 1, arranged in accordance with the present disclosure. Referring to FIGS. 2 and 3, the UE 101 observes the user 109 (i.e., Observe User) as the user operates a vehicle. Observation data may be stored on any optical, solid-state or magnetic storage device or combination thereof within the UE 101. When the user requests a route to a destination (i.e., Route Request) from UE 101, the route request generation component 202 compiles and transmits a route request message (i.e., Transmit Request). The route request message includes information about the destination and any user observations that are to be transmitted as part of the request (i.e., parameters Destination and User Observations). The request is transmitted to navigation server 102 via network interface 204. Once the route request message is received at the navigation server 102, it is processed by the navigation server 102 to determine the identity of the user 109 (i.e., Identify User in FIG. 3). The identity may be an actual unique identification of the user 109, such as a driver's license number. Typically, when a unique identification for the user 109 cannot be found, the user observation data may be analyzed by the navigation server 102 (i.e., Analyze User Observations) to identify a user group to which the user 109 belongs or may be assigned. Once the user 109 is identified or a user group is assigned, route preferences are determined (i.e., Identify Preferences) based on the available information about the user or user group data. These route preferences are used by the navigation server 102 to compile a personalized route (i.e., Compile Route) for the user 109 to the requested destination. The compiled route is provided to UE 101 (i.e., Provide Compiled Route) over network 205 and displayed for the user (i.e., Display Route) on user interface 201.

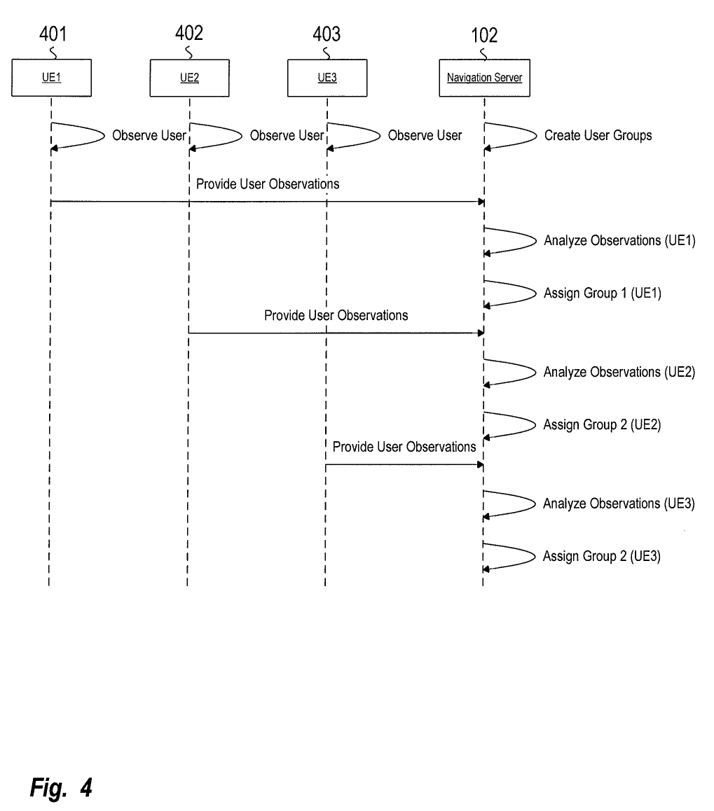

User groups may be based on demographic characteristics defining various user characteristics. FIG. 4 is a sequence diagram illustrating the process for assigning users to user groups for the personalized navigation service of FIG. 1, arranged in accordance with the present disclosure. As illustrated in FIG. 4, the navigation server 102 creates a plurality of user groups (e.g., Create User Groups), as discussed in greater detail below. User Equipment 401 (UE1), 402 (UE2), 403 (UE3) observe users (e.g., Observe User) associated with the respective UE. UE1 401 provides user observation data (e.g., Provide User Observations) to the navigation server 102. The navigation server 102 analyzes the received observations (e.g., Analyze Observations) and assigns UE1 401 to a first user group (e.g., Assign Group 1). This process (i.e., Observe User, Provide User Observations, Analyze Observations, Assign Group) is repeated for each set of observation data received from UE2 402 and UE3 403, which are assigned to a second user group (e.g., Assign Group 2) by navigation server 102. The observation data may be transmitted by a UE at any time and may be analyzed and grouped by the navigation server 102 at any time. Thus, observation data may be received prior to or in conjunction with a route request.

Demographic characteristics that may be used in creating the user groups comprise any demographic characteristics that may be determined from user data, such as age, sex, marital status, number of children, employment and income. For example, average speed, acceleration and deceleration patterns may be used to estimate the age and sex of the user. Vehicle type may be used to determine income, marital status and number of children in a household. Employment may be determined from a repetitive weekday destination driven at approximately the same time each day. These determinations are meant to be exemplary, and not exhaustive. Those skilled in the art will recognize other demographic characteristics that may be determined from the user observations. Additional information discussed previously, such as music selection and listening volume, may be used to improve the accuracy of the demographic characteristic estimates.

Selection of a user group may be based on which group best fits the identified demographics of the analyzed user. For example, an “inexperienced user” group may include all users identified as between 16 and 18 years old. A “risky user” group may include single, male users between the age of 18 and 30 with above average driving speeds. A “family user” group may include married males and females with children, with average speed within a predetermined speed limit. A “senior user” group may include males and females above age 75, with typically short driving distances and below average driving speeds. A “commuter” group may include users between ages 22 and 70 that drive long distances daily. Those skilled in the art will recognize other groups that may be formed based on identified user demographic characteristics. These groups may be created dynamically based on observation by the navigation server 102 or may be preset by private and/or government agencies. Any one or combination of various algorithms generally known in the art for performing a match determination between a user and a group may be used. Discussion of such algorithms is not included here for convenience only and is not intended to limit the scope of this disclosure.

Note that when a vehicle has multiple uses or users, observations provided by UE 101 may result in the navigation server 102 determining different user behavior at various times. For example, a 35-year-old male may be found to belong to the “family user” group when driving at an average speed below the expected speed for the user on a weekend. The same user may be found to belong to the “commuter group” when driving above an expected average speed on a weekday morning. Finally, a third driving style on a trip to the movies on a Friday evening may lead to a determination that a teenager is controlling vehicle. In such cases, a UE may be assigned to more than one user group, and, when a route request message is received, the navigation server 102 determines which user group the user issuing the particular request belongs to at that time.

Each user group may have associated route navigation policies and point of interest (POI) preferences that can be tailored to the general driving style or interests of users in the particular user group. The route navigation policies may be tailored to particular driving styles, trip types and vehicle types. For example, route navigation policies may emphasize freeways over local streets or vice-versa. Other route navigation policies may include avoiding road situations such as construction, congestion, bridges, tolls and traffic. Route navigation policies may be created based on analysis of driving styles by the navigation server 102 of users within the particular user group. Additionally, policies may be provided by any public or private agency.

Referring again to FIG. 1, the navigation server 102 may maintain or have access to a roadway information database 110 defining globally or regionally known information about particular roadways or portions thereof, including dangerous roads, intersections, access roads, as well as entrances and exits onto highways. External data sources 104, 105, 106, 107, 108 provide additional weather, road conditions, traffic, event and mapping data, respectively.

The navigation server 102 compiles environmental data from any device or network location capable of providing access to data that may be relevant to providing routing information to a user 109. Examples of data sources employed by the navigation server 102 include, without limitation, the event data source 104, the traffic data source 105, the roadway characteristics data source 106, the weather data source 107, and the geographic mapping data source 108. The navigation server 102 may request data from an external data source or the source may automatically send data to the navigation server 102 at predefined or periodic intervals. Also, the navigation server 102 can be updated with data stored on a storage medium. For example, the navigation server 102 may obtain stored data from a flexible or hard magnetic disk, a magnetic tape, an optical disk such as a CD, CD-ROM, DVD, a flash memory device, or any other type of media generally known in the art that is capable of retaining digital data used for some interval of time. Data gathered from external sources may also be stored locally inside the navigation server 102. In particular, environmental data gathered from the external sources 105, 106, 104, 107 and 108 can be stored by the navigation server 102 in one or more databases of external data 111.

The event data source 104 provides information related to events that are currently impacting traffic conditions or events that may impact traffic conditions in the future. Examples of an event or event type include, but are not limited to, sports events, concerts, political rallies, emergency events, such as a building fires or floods, terrorist acts, and community events such as street festivals or parades, and religious services. Information about an event may include the venue for the event, a start time for the event, an end time (either projected or actual), expected or actual attendance, and roadway closures and restrictions associated with the event.

The traffic data source 105 provides information related to the real-time or near real-time traffic conditions on roadways, road segments, parking areas or any other area where traffic flow or volume is impacted and/or observed. This information may include congestion levels on roadways or portions thereof, traffic flow or rate of vehicle movement, a description of current road closings, bridge and railroad gate openings, accident reports, and an indication of police activity of the roadway. In addition to current traffic information, the traffic data source may provide historical traffic data and predictions of future traffic conditions. Potential sources of traffic data include, without limitation, government agency data, roadway observations from cameras or sensors, or Internet-based traffic data aggregators. Alternatively, the navigation server 102 may record traffic data as it receives it, so that it maintains a record of historical traffic conditions. The navigation server 102 may then execute algorithms in order to forecast traffic conditions.

The roadway characteristics 106 data source provides information related to the physical characteristics of roadways, road segments, parking areas or other areas that are traversed by vehicles. This information may include, without limitation, the speed limit of each roadway or road segment, the number of lanes on the highway, exit destinations and merging roadways, weight limitations, toll locations, and capacity. The roadway characteristics database may also store information that indicates whether traffic on a roadway is controlled or uncontrolled (e.g., whether lane markings and traffic control signals are employed).

The weather data source 107 provides real-time or near real-time data (both raw and composite) related to current and historical weather conditions, as well as a prediction of future weather conditions, including radar and satellite data, temperature, wind and other generally observed weather conditions. Weather events tracked by the weather data source 107 include, without limitation, sunshine, clouds, rain, tornados, hail, snow, ice, thunderstorms, tropical storms and hurricanes. The weather data source may also provide an indication of natural disasters such as avalanches, earthquakes, floods, tsunamis, volcanic eruptions, landslides, hurricanes, tropical storms, and mudslides. If a weather event is currently occurring, the weather data source 107 may provide an indication of the location of the event, as well as an indication of locations that will be impacted in the future. Radar and/or satellite data from one or multiple radar or satellite sources may also be provided by the weather data source 107.

Geographic mapping data may be gathered from one or more mapping data sources 108 that provide mapping data that describes a plurality of roadways as well as the location of major landmarks. Roadways that are specified in the geographic mapping data may include, without limitation, interstate highways, intrastate highways, local roads, and residential streets. Each roadway may be described as single item or a roadway may be partitioned into one or more road segments (i.e., any section of a roadway that is utilized by travelers). Road segments may be further described by suggested usage. For example, a road segment that is a portion of a major highway may be described as usable by vehicles, but not pedestrians. Landmarks included in the geographical mapping data may aid in the prediction of increased traffic conditions. Such landmarks may include, without limitation, police and fire stations, amusement parks, arenas, stadiums, parks, marinas, airports, restaurants, shopping malls, and churches.

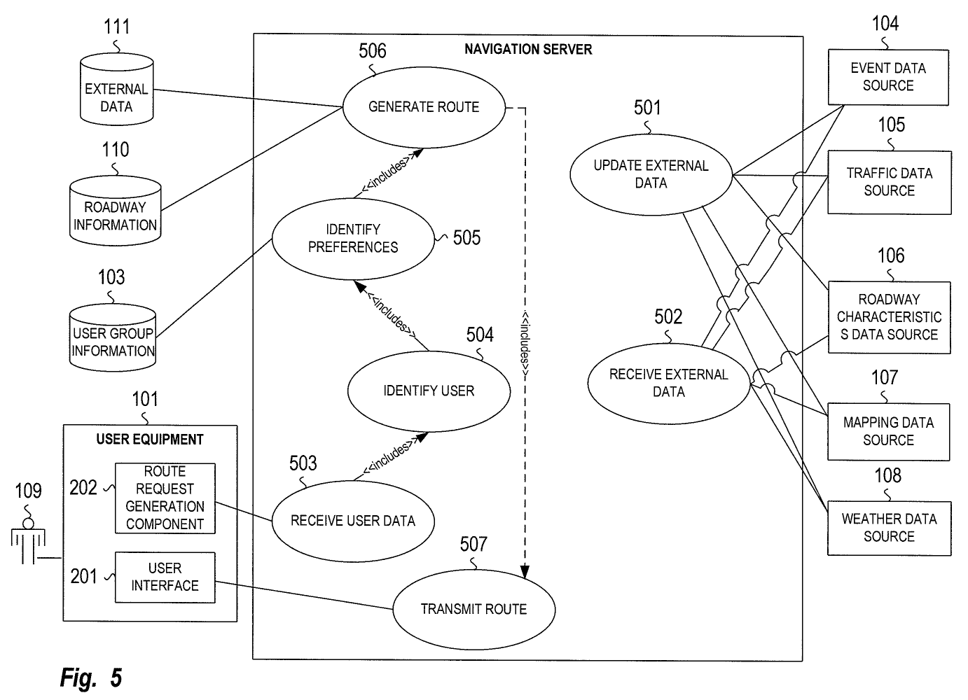

FIG. 5 is a use case diagram associated with determining a personalized route for the personalized routing service of FIG. 1, arranged in accordance with the present disclosure. The navigation server 102 includes an update external data use case 501 that interacts with respective data sources 104, 105, 106, 107 and 108 to update those sources as necessary. Similarly, a receive external data use case 502 receives external data as may be required from the data sources 104, 105, 106, 107 and 108. The received external data may be used in whole or in part to create a route. Receive user data use case 503 interacts with route request generation component 202 of UE 101 to receive messages. The receive user data use case 503 receives both route requests and user observation data from the UE 101. Identify user use case 504 analyzes user observation data received by receive user data use case 503 to determine an identity of the user 109 associated with UE 101. The identify user use case 504 can assign user 109 to a user group if it is unable to locate a unique identifier for the user 109. The identity of the user determined by use case 504 and data stored in the user group information database 103 are used by an identify preferences use case 505 to identify route navigation preferences and POI preferences for user 109. A generate route use case 506 uses the identified preferences, external data and any available internal roadway data in the roadway information database 110 to create a customized route and recommendations for user 109. A transmit route use case 507 interacts with UE 101 to provide the route created by the generate route use case 506 for display by user interface 201 of UE 101.

In the generate route use case 506, the navigation server 102 may use the database of roadway information 110 along with data received from external data sources 104, 105, 106, 107 and 108 to route users according to current conditions and determined preferences for the identified user. For example, a user identified as belonging to an “inexperienced user” group may be assigned a policy of avoiding difficult merges. Thus, if the user must travel on an interstate highway, and if the nearest entrance to the highway has a very short acceleration lane, the navigation server 102 may calculate a route with an entrance to the highway having an easier merge.

In addition to route navigation policies, each user group may be assigned particular POI preferences. The POI preferences may be defined based on observations of users' stops during travel. These POI preferences may vary based on data available about the particular trip. POIs may be stored in a database (not shown) and may include a directory of all available POIs in a particular locale, categorized based on type of POI. Advertisers may wish to feature their products or services to the user by purchasing a featured POI. Featured POIs may be presented to the user via UE 101, and may include additional data such as a logo for the featured item along with any additional information the advertiser would like to display. As an example, it may be determined that users belonging to the “commuter” group stop at a coffee shop during morning commutes. Accordingly, coffee shops along the route may purchase advertising in the “commuter” group to present locations of such coffee shops along a user's route to work. Similarly, it may be determined that on a Friday or Saturday evening, users belonging to the “inexperienced user” group often travel to the movie theater. In this case, movie theaters and movie listings may be transmitted and displayed on the navigation device.

POI preferences may be dynamically selected based on, for example, time of travel, day of travel or duration of the trip. Thus, a user in the “family user” group may be presented playground POIs on a Saturday morning and family restaurants POIs around lunchtime. While in addition to cafes presented in the morning commute, a user in the “commuter” group could be recommended grocery stores during the evening commute.

Though POIs may be automatically presented on the UE 101 as previously discussed, they may also be presented as recommendations to be selected from by the user. For example, if it is determined that a vehicle is being operated by a user from the “inexperienced user” group on a Friday evening, the UE 101 may present entertainment options, including bowling alleys, miniature golf courses, movie theaters and shopping malls. An advertiser may purchase a featured listing in the recommendations for any of the POI categories and in any user group.

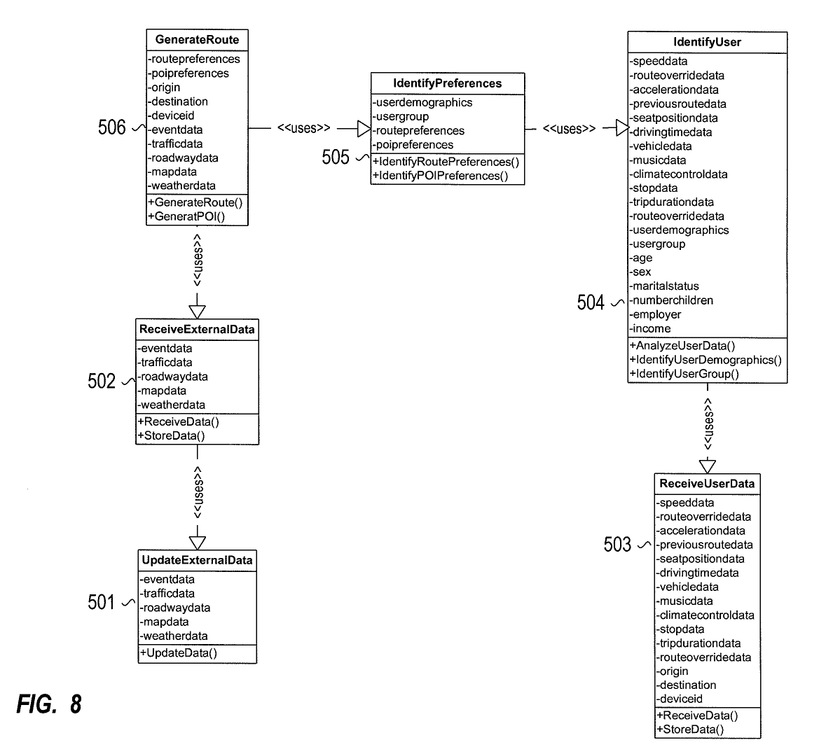

FIG. 8 is a class diagram associated with determining a personalized route for the personalized routing service of FIG. 1, arranged in accordance with the present disclosure. The data fields shown in the classes of FIG. 8 help define stored data that is drawn on by navigation server 102 (not shown) to fulfill a personalized route request. The use of classes does not constrain the types of data to be indexed, stored, organized or manipulated, nor does it limit the mechanisms by which that data is managed. For example, in some embodiments, a relational database may be employed to store the user information, while in other embodiments an object oriented database is used. In order to receive updated external information for creating a route, a generate route class 506 (GenerateRoute) uses receive external data class 502 (ReceiveExternalData), which uses an update external data class 501 (UpdateExternalData). In order to determine preferences associated with a route request, the generate route class 506 uses an identify preferences class 505 (IdentifyPreferences). Identify preferences class 505 uses identify user class 504 (IdentifyUser) to determine user demographics or assign a user group. Identify user class 504 uses receive user data class 503 (ReceiveUserData) to receive data associated with the route request.

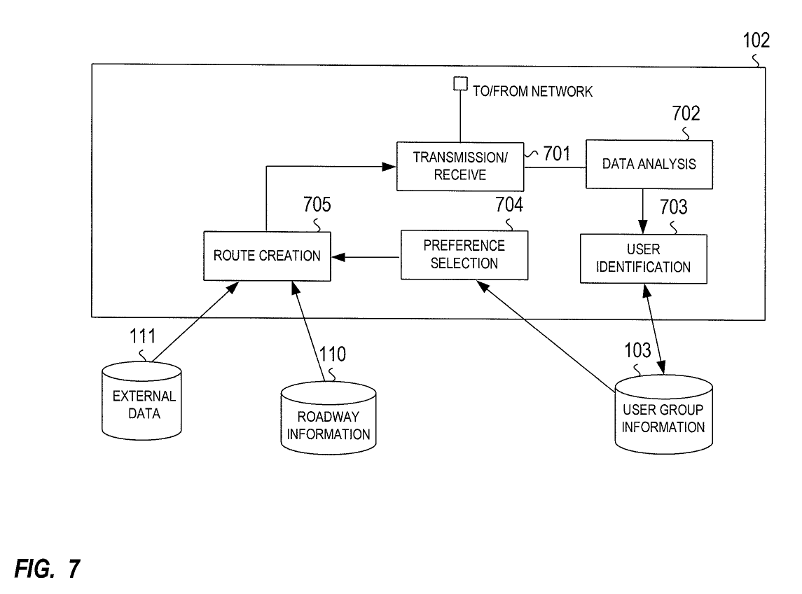

FIG. 7 is a block diagram illustrating a navigation server 102 according to the personalized navigation service of FIG. 1, arranged in accordance with the present disclosure. The navigation server 102 may include one or more of a receiver/transmitter 701, a data analysis module 702, a user identification module 703, a preference selection module 704 and a route creation module 705. An example network interface 701 functions as a receiving and transmitting module for communicating with the UE 101 via the network 205 (see FIG. 1). Data received by the network interface 701 includes, but is not limited to route requests and observation data from UE 101 and external data from external data sources 104, 105, 106, 107 and 108. Data received by the navigation server 102 can be analyzed by the data analysis module 702 and separated between observation data, route requests and external environment data. The user identification module 703 can be employed to determine an identity of the user associated with a route request. The user identification module 703 is configured to assign a user group to the requesting user if a user group is required. In making a group assignment, the user identification module 703 may use data stored in user group information database 103. The preference selection module 704 can be configured to identify preferences associated with the identified user based on either actual observations or based on policies for the assigned user group. Preference selection module 704 may use data stored in user group information database 103. The route creation module 705 can be used to incorporate user preferences from preference selection module 704 in compiling a route for the requesting user. Route creation module 705 may use data stored in external data databases 111 and roadway information databases 110 when compiling the personalized route. The network interface can also function as a transmission module for sending compiled navigation routes to the UE 101 of the requesting user.

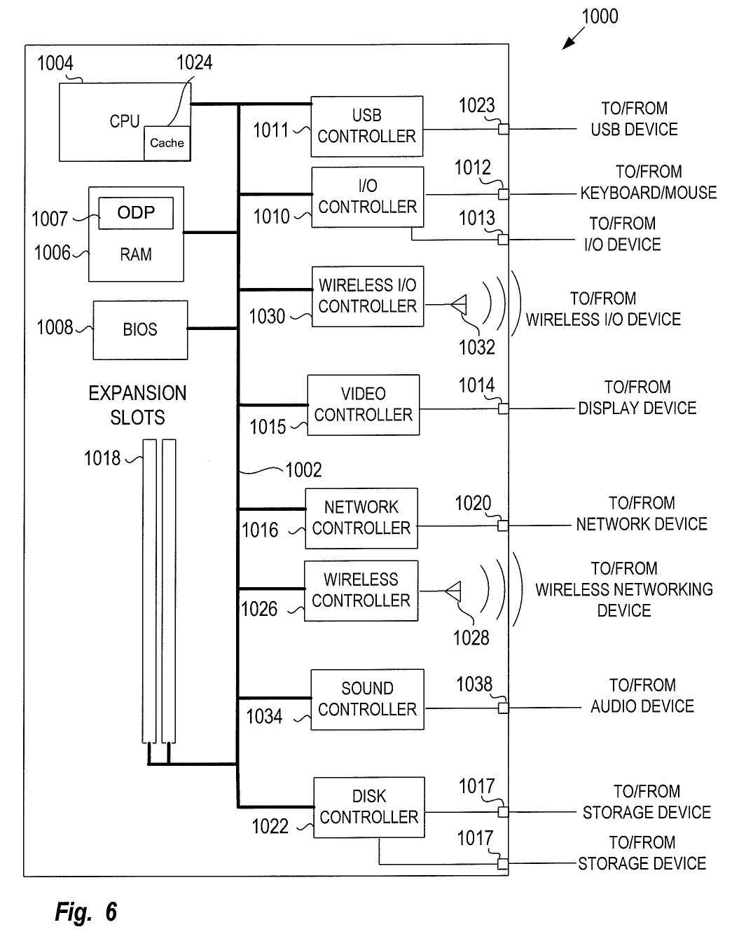

FIG. 6 is a block diagram illustrating a computer architecture or system 1000 through which the presently disclosed embodiments of the personalized navigation service 100, including the navigation server 102 and the user equipment 101 (or portions thereof), may be realized and/or implemented. A system bus 1002 transports data amongst the Central Processing Unit (CPU) 1004, RAM 1006, the Basic Input Output System (BIOS) 1008 and other components. The RAM 1006 may include an observation data process (ODP) 1007. The observation data process 1007 may collect and/or analyze the observation data described above with reference, for example, to the UE 101 and/or the navigation server 102 and FIGS. 3-5 and 8. The RAM 1006 as shown in FIG. 6 is an example only and other aspects of the subject matter of the present disclosure could be implemented with the architecture of FIG. 6, with or without the observation data process 1007 as shown in the RAM 1006 of FIG. 6. The CPU 1004 may include a cache memory component 1024. The computer system 1000 may include one or more external storage ports 1017 for accessing a hard disk drive (HDD), optical storage drive (e.g., CD-ROM, DVD-ROM, DVD-RW), flash memory, tape device, or other storage device (not shown). The relevant storage device(s) are connected through the external storage port 1017 which is connected to the system bus 1002 via a disk controller 1022. A keyboard and pointing device (e.g. mouse. touch pad) (not shown) can be connected to the keyboard/mouse port(s) 1012, and other I/O devices could be connected to additional I/O port(s) 1013, which are connected to the system bus 1002 through the I/O controller 1010. Additional ports or devices, such as serial ports, parallel ports, firewire adapters, or biometric devices (not shown), may be utilized through the I/O controller 1010. A display device (not shown) can be connected to a display device port 1014 which is connected to the system bus 1002 through the video controller 1015. A network device (not shown), including but not limited to an Ethernet device or other device having networking capability, can be connected to a network port 1020 which is connected through the network controller 1016 to the system bus 1002. The computer system 1000 may be wirelessly connected to a network device that is configured for wireless operation (not shown), including but not limited to wireless routers, using an antenna 1028 connected to a wireless controller 1026 connected to the system bus 1002, where the antenna transmits/receives signals to/from the network device. The computer system 1000 may include one or more USB ports 1023. A USB device (not shown), including but not limited to a printer, scanner, keyboard, mouse, digital camera, storage device, PDA, cellular phone, biometric device, webcam, and I/O adapters can be connected to the USB port 1023 which is connected to the system bus 1002 through the USB controller 1011. Other devices, such as cellular phones, PDAs, and other portable devices may also be connected wirelessly via a wireless 1/0 antenna 1032 that is connected to a wireless I/O controller 1030. Examples of wireless I/O technologies include, but are not limited to, Bluetooth, Infrared (IR), and Radio-Frequency (RF). Audio devices, such as microphones, speakers, or headphones may be connected to a sound port 1038 that is connected to a sound controller 1034 that is connected to the system bus 1002. Expansion slots 1018 can be comprised of Industry Standard Architecture (ISA) slots, Peripheral Component Interconnect (PCI) expansion slots, PCI Express expansion slots, Accelerated Graphics Port (AGP) slots or any other slot generally known in the art to allow additional cards to be placed into the computer system 1000. These slots can be used to connect network cards, video cards, sound cards, modems and any other peripheral devices generally used with a computer. The computer system 1000 also includes a source of power (not shown), including but not limited to a power supply connected to an external source of power, and an internal or external battery. Detailed descriptions of these devices have been omitted for convenience only and should not be construed as limiting.

The embodiments of the present disclosure may be implemented with any combination of hardware and software. If implemented as a computer-implemented apparatus, the embodiment is implemented using means for performing all of the steps and functions described above.

The embodiments of the present disclosure can be included in an article of manufacture (e.g., one or more computer program products) having, for instance, computer useable media. The media has embodied therein, for instance, computer readable program code means for providing and facilitating the mechanisms of the embodiments of the present disclosure. The article of manufacture can be included as part of a computer system or sold separately.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a flexible disk, a hard disk drive (HDD), a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method of personalizing navigation for a user on a computer system by evaluating user observation data received from a navigation device remote from the computer system over a network, the method for the computer system comprising:
receiving from the navigation device, at the computer system, the user observation data and a route request associated with the user;
determining a user identity associated with the route request based at least in part on the received user observation data;
evaluating one or more preferences to identify a specific preference associated with the user identity;
compiling, on a processing module, a route based at least in part on the specific preference; and
providing the compiled route over the network to the navigation device.

2. The method of claim 1, wherein the specific preference corresponds to one or more of a route navigation preference, a point of interest preference, or a combination thereof.

3. The method of claim 1, further comprising providing point of interest information associated with the compiled route to the navigation device when the specific preference corresponds to the point of interest.

4. The method of claim 1, wherein the navigation device is a global positioning system navigation device.

5. The method of claim 4, wherein the user observation data corresponds to one or more of an acceleration pattern, an average vehicle speed, or a combination thereof.

6. The method of claim 1, wherein determining the user identity comprises:
identifying demographic characteristics associated with the user;
identifying a user group for the user based on the determined demographic characteristics; and
assigning the user to the identified user group.

7. The method of claim 1, wherein the user is a vehicle driver.

8. A navigation server that is arranged in communication with a navigation device, the navigation server comprising:
a receive module configured to receive observation data and route request messages from the navigation device;
a user identification module configured to determine a user identity associated with the route request messages based at least in part on the received observation data;
a preference selection module configured to identify a preference associated with the determined user identity;
a route creation module configured to compile a route based at least in part on the identified preference; and
a transmission module configured to provide the compiled route to the navigation device.

9. The navigation server of claim 8, wherein the identified preference corresponds to one or more of a route navigation preference, a point of interest preference, or a combination thereof.

10. The navigation server of claim 8, wherein the transmission module is further configured to provide point of interest information associated with the compiled route to the navigation device when the identified preference corresponds to the point of interest preference.

11. The navigation server of claim 8, wherein the navigation device is a global positioning system navigation device.

12. The navigation server of claim 11, wherein the observation data corresponds to one or more of an acceleration pattern, an average vehicle speed, or a combination thereof.

13. The navigation server of claim 8, wherein the user identification module is further configured to:
identify demographic characteristics associated with the user identity;
identify a user group for the user based on the determined demographic characteristics; and
assign the user identity to the matched user group.

14. The navigation server of claim 8, wherein the user is a vehicle driver.

15. An article of manufacture for personalizing navigation for a user by evaluating user observation data received from a remotely located navigation device, the article of manufacture comprising a computer-readable medium holding computer-executable instructions for performing a method comprising:
receiving user observation data and a route request associated with the user from the navigation device;
determining a user identity associated with the route request based at least in part on the received user observation data;
evaluating one or more preferences to identify a specific preference associated with the user identity;
compiling a route based at least in part on the specific preference; and
providing the compiled route to the navigation device.

16. The article of manufacture of claim 15, wherein the specific preference corresponds to one or more of a route navigation preference, a point of interest preference, or a combination thereof.

17. The article of manufacture of claim 15, further comprising providing point of interest information associated with the compiled route to the navigation device when the specific preference corresponds to the point of interest.

18. The article of manufacture of claim 15, wherein the navigation device is a global positioning system navigation device.

19. The article of manufacture of claim 18, wherein the user observation data corresponds to one or more of an acceleration pattern, an average vehicle speed, or a combination thereof.

20. The article of manufacture of claim 15, wherein determining the user identity comprises:
identifying demographic characteristics associated with the user;
identifying a user group for the user based on the determined demographic characteristics; and
assigning the user to the identified user group.
